(19) United States
(12) Patent Application Publication
(10) Pub. No.: US 2020/0260666 A1
(43) Pub. Date: Aug. 20, 2020

(54) HYDROPONIC CULTIVATION APPARATUS

(71) Applicant: Panasonic Intellectual Property Management Co., Ltd., Osaka (JP)

(72) Inventors: Satoshi OGATA, Osaka (JP); Tarou ISHIDOU, Kyoto (JP)

(73) Assignee: Panasonic Intellectual Property Management Co., Ltd., Osaka (JP)

(21) Appl. No.: 16/061,447

(22) PCT Filed: Dec. 9, 2016
(86) PCT No.: PCT/JP2016/005091

§ 371 Date: Jun. 12, 2018

(30) Foreign Application Priority Data
Feb. 8, 2016 (JP) 2016-021862

(51) Int. Cl. A01G 31/02

(52) U.S. Cl. CPC A01G 31/02

(57) ABSTRACT

The hydroponic cultivation apparatus comprises: a cultivation tank that has a light shielding property and is configured to accommodate underground part of a plant; a partitioning portion that has a light shielding property and that is configured to cover the opening at the upper end of the cultivation tank and partitions an underground space where the underground part of the plant grows and an aboveground space where aboveground part of the plant grows, wherein the partitioning portion includes; a fixed member, a position of which is fixed with respect to the cultivation tank, and including a through hole surrounding a stem of the plant and maintains a closed state where it is suppressed that light is irradiated to the underground part of the plant; and a door member that is attached to the fixed member in a state where it is movable with respect to the fixed member and changes to a closed state where it is suppressed that light is irradiated to the underground part of the plant and to an open state where it is possible to view the underground part.

### TECHNICAL FIELD

The present invention relates to a hydroponic cultivation apparatus for cultivating plants without using soil.

### BACKGROUND ART

In conventional hydroponic cultivation apparatuses, as described in the following Patent Literature 1, a partitioning portion that partitions an aboveground space where aboveground part of a plant grows and an underground space where underground part of the plant grows is provided in a cultivation tank. A light source is provided in the aboveground space. Therefore, light emitted by the light source is irradiated to the aboveground part of the plant, but is blocked by the partitioning portion. As a result, the light emitted by the light source does not reach the underground part of the plant.

### CITATION LIST

### Patent Literature

Patent Literature 1: Japanese Unexamined Patent Application Publication No. 2010-268787

### SUMMARY OF INVENTION

### Problem to be Solved by Invention

According to the conventional hydroponic cultivation apparatuses described above, after installing the partitioning member to the cultivation tank, in order to observe the underground part of the plant, it is necessary to remove the partitioning portion from the cultivation tank. Therefore, work to observe the underground part of the plant becomes complicated.

The present invention has been made in view of such conventional problems. It is an object of the present invention to provide a hydroponic cultivation apparatus which can readily perform the work of observing underground part of a plant.

### SOLUTION TO PROBLEM

A hydroponic cultivation apparatus according to an aspect of the present invention comprising: a cultivation tank that has a light shielding property and is configured to accommodate underground part of a plant; and a partitioning portion that has a light shielding property and that is provided so as to cover an opening at an upper end of the cultivation tank and partitions an underground space where the underground part of the plant grows and an aboveground space where aboveground part of the plant grows, the partitioning portion includes: a fixed member, a position of which is fixed with respect to the cultivation tank, and that has a through hole surrounding a stem of the plant and maintains a closed state where it is suppressed that light is irradiated to the underground part of the plant; and a door member that is attached to the fixed member in a state of being movable with respect to the fixed member and changes to a closed state where it is suppressed that light is irradiated to the underground part of the plant and to an open state where it is possible to view the underground part of the plant.

### EFFECT OF INVENTION

According to the present invention, it is possible to readily perform the work of observing underground part of a plant.

### BRIEF DESCRIPTION OF DRAWINGS

FIG. 1 is an exploded plan view of a partitioning portion of a hydroponic cultivation apparatus of an embodiment.

FIG. 2 is a view showing a state in which a part of a partitioning portion of the hydroponic cultivation apparatus of the embodiment is installed above the cultivation tank.

FIG. 3 is a view showing a state in which all the partitioning portions of the hydroponic cultivation apparatus of the embodiment are installed above the cultivation tank.

FIG. 4 is an exploded plan view of a light shielding member of the hydroponic cultivation apparatus of the embodiment.

FIG. 5 is an exploded cross-sectional view of a light shielding member of the hydroponic cultivation apparatus of the embodiment.

FIG. 6 is a perspective view showing the whole configuration of the hydroponic cultivation apparatus of the embodiment.

FIG. 7 is a schematic longitudinal sectional view of the hydroponic cultivation apparatus of the embodiment, in which a door member is closed.

FIG. 8 is a schematic longitudinal sectional view of the hydroponic cultivation apparatus of the embodiment, in which the door member is opened.

FIG. 9 is a schematic longitudinal sectional view of a modified example of the hydroponic cultivation apparatus of the embodiment, in which the door member is opened.

### DESCRIPTION OF EMBODIMENTS

Hereinafter, a hydroponic cultivation apparatus of an embodiment will be described with reference to the drawings.

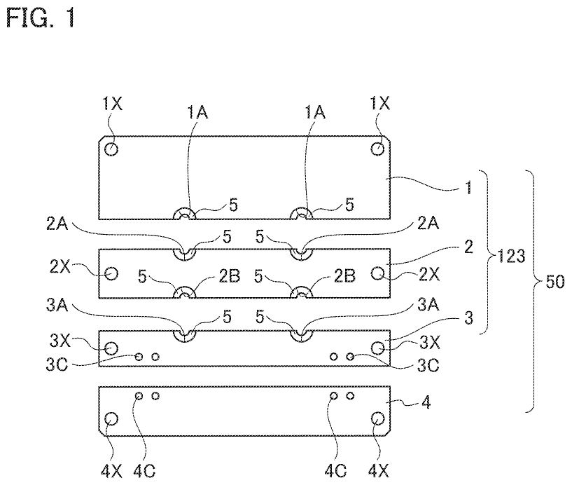

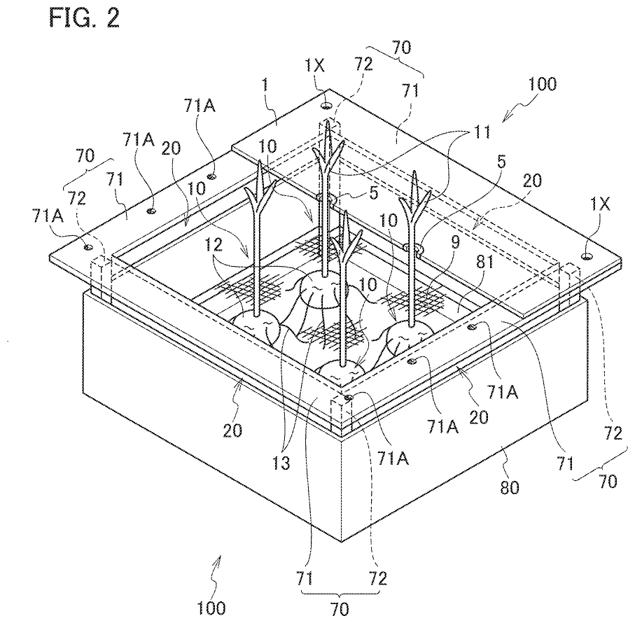

As shown in FIG. 1, the hydroponic cultivation apparatus of the embodiment is provided with a partitioning portion 50 that has light shielding property. The partitioning portion 50 is for preventing light from reaching underground part of a plant, as described in detail below. The partitioning portion 50 comprises a fixed member 123 and a door member 4. The fixed member 123 is fixed indirectly to a cultivation tank to be described below via a supporting portion 70 (see FIG. 2) to be described. The door member 4 is attached to the fixed member 123 so as to be movable with respect to the fixed member 123, as described below.

The fixed member 123 comprises a plate like member 1, a plate like member 2 adjacent to the plate like member 1, and a plate like member 3 adjacent to the plate like member 2. The door member 4 is a plate like member adjacent to the plate like member 3.

The plate like member 1 has two through holes 1X penetrating in its thickness direction and two semicircular shapes of notches 1A that are formed on the end surface adjacent to the plate like member 2. Screws to be described below are inserted into the two through holes 1X. Arcuate shape of elastic members 5 are attached to the notches 1A.

The plate like member 2 has two through holes 2X penetrating in its thickness direction. Screws to be described below are inserted into the two through holes 2X. The plate like member 2 has two semicircular shapes of notches 2A that are formed on the end surface adjacent to the plate like member 1 and two semicircular shapes of notches 2B that are formed on the end surface adjacent to the plate like member 3. The semicircular shape of notch 1A of the plate like member 1 and the semicircular shape of notch 2A of the plate like member 2 form one circular through hole as a whole. Elastic members 5, each of which has an arcuate like shape, are attached to the notch 2A and the notch 2B, respectively.

In the plate like member 3, two through holes 3X penetrating in its thickness direction are formed. Screws to be described below are inserted into the two through holes 3X. The plate like member 3 has two semicircular shapes of notches 3A that are formed on the end surface adjacent to the plate like member 2. The semicircular shape of notch 2B of the plate like member 2 and the semicircular shape of notch 3A of the plate like member 3 form one circular through hole as a whole. The elastic member 5, which has an arcuate like shape, is attached to the notch 3A. Further, four screw holes 3C are formed in the plate like member 3. Screws to be described below are screwed into the four screw holes 3C.

As can be understood from the above, the plate like member 1 and the plate like member 2 adjacent thereto have a pair of notches 1A and 2A on a pair of opposing surfaces facing each other. The plate like member 2 and the plate like member 3 adjacent thereto have a pair of notches 2B and 3A on a pair of opposing surfaces facing each other. These pairs of notches form the aforementioned through hole as a whole.

In the door member 4, two through holes 4X and four screw holes 4C penetrating in its thickness direction are formed. Screws for temporary fixing, which will be described below, are inserted into the two through holes 4X. Screws to be described below are screwed into the tour screw holes 4C. The door member 4 constitutes the plate like member at the outermost, that is, the end portion of the plurality of plate like members arranged side by side along one direction.

The elastic member 5 described above is elastically deformed according to a shape of a stem of a plant. Each of the plurality of elastic members 5 is preferably a member having flexibility and is, more preferably, a member such as a urethane sponge (urethane foam), or a rubber sponge, for example. The elastic member 5 is preferably black which absorbs light. In this case, the opposing two of elastic members 5 cooperatively plug the gaps between each of the notches 1A, 2A, 2B, 3A, and 313 and the stem as the aboveground part 11 while deforming elastically. Therefore, at the same time at which the partitioning portion 50 is installed, it is possible to close the gaps between the openings and the sterns.

Since the partitioning portion 50 is for suppressing the arrival of light to the underground parts 12, it is desirable that the partitioning portion 50 has a color that absorbs light such as black. Even if there is a small gap between the plate like members 1, 2, or 3 or between the plate like member 3 and the door member 4, since the black absorbs the light, it is possible to keep the underground space in a dark state.

In the present embodiment, as described above, the notches of plate like members of the partitioning portion 50, which are mutually opposing, as a whole form a circular opening through which the stem of the plant penetrates. However, the notch constituting the opening through which the stem of the plant penetrates may be provided only in one plate like member. Further, the shape of the opening need not be circular as long as the stem of the plant 10 is not damaged. Furthermore, for example, if the diameter of a circular opening formed by a pair of semicircular notches is about 4 cm, in some cases, it is suitable for bunching about four stems. The gap between the circular opening and the stem may be covered with a flexible light shielding sheet that covers the entire of the partitioning portion 50 but has holes through which only a plurality of stems penetrates.

As shown in FIG. 2, the hydroponic cultivation apparatus 100 comprises a cultivation tank 80. The cultivation tank 80 is provided with a supporting portion 70 for supporting the partitioning portion 50 described above. The supporting portion 70 comprises four pillar portions 72 extending upward and downward from the inside of each of the four corners of the cultivation tank 80. The supporting portion 70 comprises a frame portion 71 having four rectangular shapes. The four corner portions of the frame portion 71 of the rectangular shape are fixed to the upper ends of the four pillar portions 72, respectively.

As shown in FIG. 2, at the time of assembling the hydroponic cultivation apparatus 100, first, the plate like member 1 is placed on the frame portion 71. In the frame portion 71, a through hole 71A penetrating in its thickness direction is formed. Between the frame portion 71 and the cultivation tank 80, there exists a gap serving as a flow path 20 of air for communicating the internal space of the cultivation tank 80 with the external space of the cultivation tank 80.

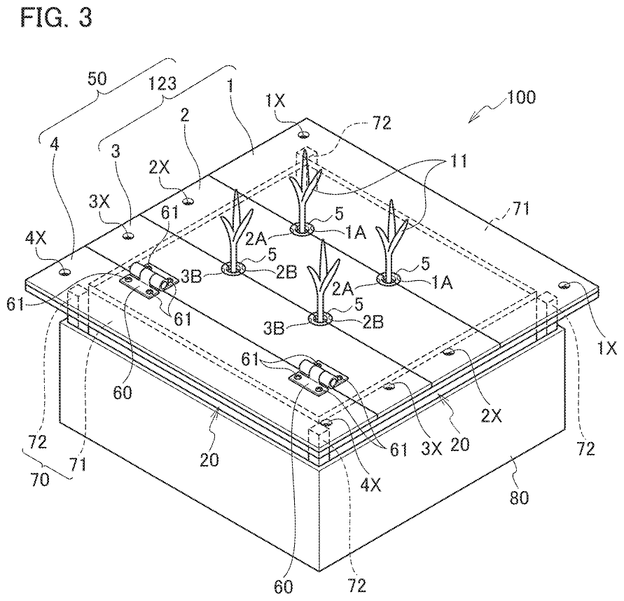

The underground part 12 of the plant 10 is positioned on a wire net 9 so that the of the plant 10 comes into contact with the elastic member 5 of an arced shape. The aboveground part 11 of the plant 10 protrudes upward from the partitioning portion 50. As for FIGS. 2 and 3, they are depicted so that a gap exists between the stem of the plant 10 and the elastic member 5, but there may be no gap between the stem of the plant 10 and the elastic member 5.

The cultivation tank 80 accommodates the underground part 12 of the plant 10. In the cultivation tank 80, the wire net 9 is provided. The underground part 12 of the plant 10 is placed on the wire net 9. The wire net 9 is fixed to the four pillar portions 72. Roots 13 extending from the underground part 12 of the plant 10 penetrate the meshes of the wire net 9 and are immersed in a nutrient solution 81 stored at the bottom of the cultivation tank 80 below the wire net 9. The plant 10 absorbs the nutrient solution 81 from the roots 13 and grows.

As shown in FIG. 3, the plate like member 2, the plate like member 3 and the door member 4 are placed on the supporting portion 70. Thereafter, the eight screws 61 are screwed into the four screw holes 3C and the four screw holes 4C that are shown in FIG. 1, respectively. Thereby, the two hinges 60 are fixed to the plate like member 3 and the door member 4 by the eight screws 61. Accordingly, the door member 4 is rotatable about the rotation axis common to the two hinges 60. In other words, the door member 4 is in a state where the same can be opened or closed.

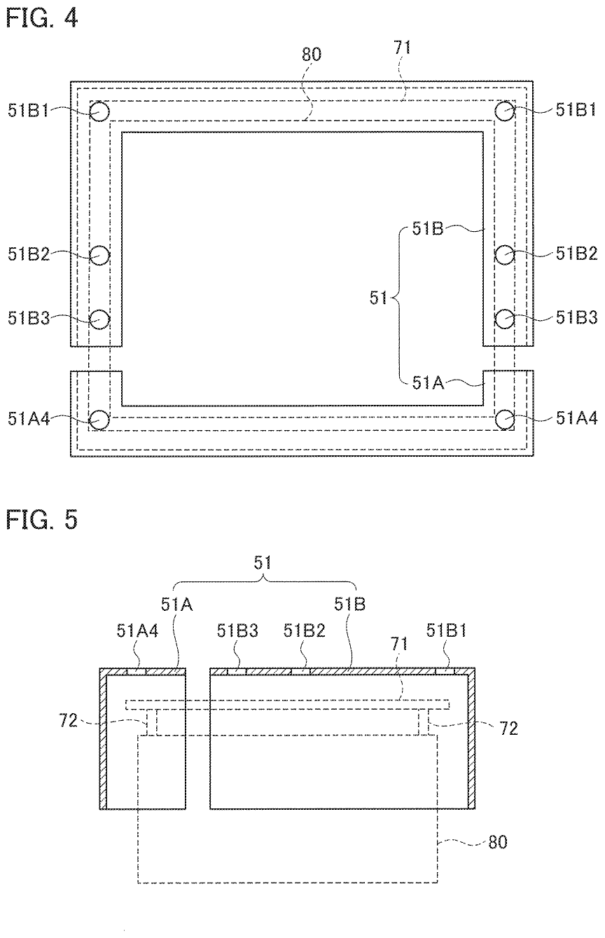

As shown in FIGS. 4 and 5, the hydroponic cultivation apparatus 100 comprises a light shielding member 51. The light shielding member 51 includes a fixed light shielding member 51B and a door light shielding member 51A. In the fixed light shielding member 51B, through holes 51B1, 51B2, and 51B3 penetrating in its thickness direction are formed. In the door light shielding member 51A, a through hole 51A4 penetrating in its thickness direction is formed.

As shown in FIGS. 4 and 5, the partitioning portion 50 is provided at a position above the cultivation tank 80 so as to cover the opening at the upper end of the cultivation tank 80. The light shielding member 51 is fixed to the partitioning portion 50. The light shielding member 51 is formed by integrating the fixed light shielding member 51B and the door light shielding member 51A. As can be inferred FIG. 4, in a plan view, the light shielding member 51 constitutes a frame like member surrounding the four side surfaces of the cultivation tank 80, and as can be inferred from FIG. 5, in a cross-sectional view, the light shielding member 51 constitutes a drop curtain like member covering the upper portions of the side surfaces of the cultivation tank 80.

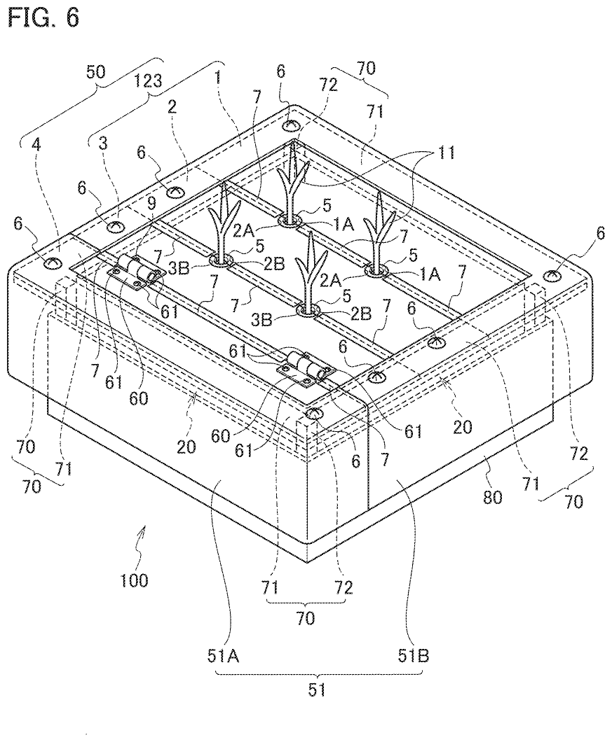

As shown in FIG. 6, the partitioning portion 50 and the light shielding member 51 are fixed to the frame portion 71 by using the eight screws 6, respectively. Specifically, the six screws 6 are inserted into the six through holes 51B1, 51B2, and 51B3 of the fixed light shielding member 51B and the six through holes 1X, 2X, and 3X of the plate like members 1, 2, and 3 corresponding thereto, respectively. Further, the six screws 6 are inserted into the six through holes 71A of the frame portion 71 corresponding to the six through holes 1X, 2X, and 3X of the plate like members 1, 2, and 3. Thereafter, the six screws 6 are screwed into female screw portions (not shown) formed in the six through holes 71A, respectively. According to this, the positions of the plate like members 1, 2, and 3 with respect to the cultivation tank 80 can be fixed, Therefore, it is possible to suppress the stem of the plant 10 from damaging due to the movement of the partitioning portion 50.

Two screws 6 for temporary fixing are respectively inserted into the two through holes 51A4 of the door light shielding member 51A and the two through holes 4X of the door member 4 corresponding thereto. Further, the two screws 6 for temporary fixing are respectively inserted into the two through holes 4X of the door member 4 and the two through holes 71A of the frame portion 71 corresponding thereto. The through holes 71A of the frame portion 71 corresponding to the through holes 4X of the door member 4 do not have female screw portions. Therefore, since the two screws 6 for temporary fixing described above are not screw-fixed, they move together with the door member 4 depending on the opening and closing operation of the door member 4.

As shown in FIG. 6, the light shielding member 7 is provided on the partitioning portion 50. The six light shielding members 7 are provided so as to straddle two adjacent plate like members of the plate like members 1, 2, and 3. The other three light shielding members 7 are provided so as to straddle the plate like member 3 and the door member 4. The light shielding member 7 covers each of a gap between the plate like members 1, 2, and 3 as well as a gap between the plate like member 3 and the door member 4. According to this, it is possible to prevent light from entering the cultivation tank 80 through the gap between the plate like members 1, 2, and 3 as well as the gap between the plate like member 3 and the door member 4. The light shielding member 7 may be stuck to the plate like members 1, 2, and 3 like an adhesive tape. In addition, the light shielding member 7 may be one in which light shielding multi-sheets generally used in agriculture are pasted with an adhesive. In addition, the light shielding member 7 may be a plastic sheet. It is preferable that the light shielding member 7 has black color from the viewpoint of light absorption.

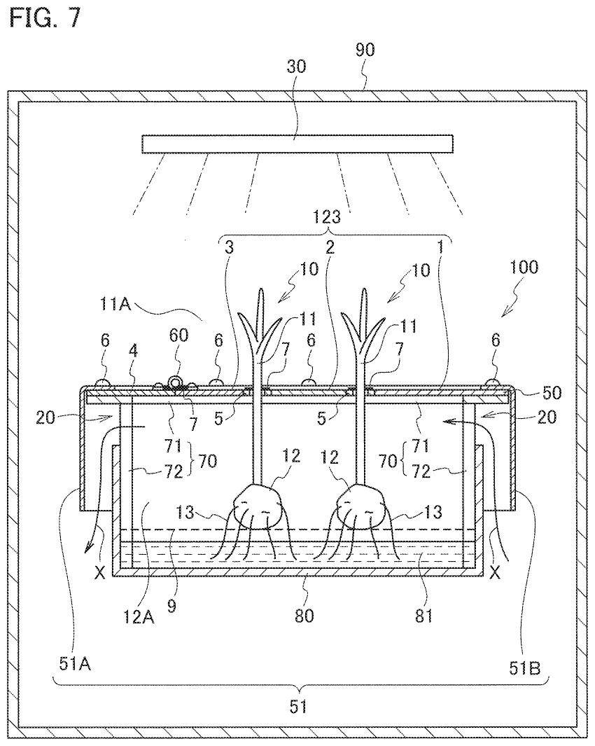

As shown in FIG. 7, the hydroponic cultivation apparatus 100 is provided in a housing 90 that is provided with a door through which a breeder of the plant 10 can enter and leave. A lighting portion 30 is provided in the housing 90. When leaves are formed on the aboveground part 11 of the plant 10, the leaves photosynthesize by light emitted from the lighting portion 30. As described above, the roots 13 extending from the underground part 12 of the plant 10 pass through the meshes of the wire net 9 and are immersed in the nutrient solution 81. Therefore, the plant 10 can absorb the nutrient solution 81 from the roots 13.

As shown in FIG. 7, the light shielding member 51 surrounds the outer surfaces of the cultivation tank 80 in a plan view and hangs down from the outer periphery of the partitioning portion 50 so that the flow path 20 of air extends downward along the outer surfaces of the cultivation tank 80. The light shielding member 51 includes the fixed light shielding member 51B that is attached to the fixed member 123 and the door light shielding member 51A that is attached to the door member 4 and is separated from the fixed light shielding member 51B.

As can be understood from FIG. 7, the flow path 20 of air exists between the partitioning portion 50 and the cultivation tank 80. Further, as can be inferred from FIG. 7, the outer periphery of the frame portion 71 is one size larger than the outer periphery of the cultivation tank 80 in a plan view. Therefore, the flow path 20 of air also extends between the outer surfaces of the cultivation tank 80 and the upward and downward extending portion of the light shielding member 51. Therefore, for example, as shown by the arrow X, an air flow is generated along the flow path 20 of air, and thereby, the atmosphere inside the cultivation tank 80 and the outside atmosphere naturally exchange. In addition, the flow path 20 of air between the partitioning portion 50 and the cultivation tank 80 is covered with the light shielding member 51. Therefore, it is suppressed that light is irradiated to the underground part 12 of the plant 10 in the cultivation tank 80.

According to the above-described configuration, even if air is allowed to flow naturally between the inner space of the cultivation tank 80 and the outer space of the cultivation tank 80 via the flow path 20 of air, the light shielding member 51 suppresses light from entering the inside of the cultivation tank 80 from the lateral position of the cultivation tank 80 via the flow path 20 of air. In addition, the breeder of the plant 10 can readily open the door member 4 together with the light shielding member 51, when viewing the space inside the cultivation tank 80.

In the present embodiment, the supporting portion 70 has a framework structure, and the gap between the cultivation tank 80 and the frame portion 71 constitutes the flow path 20 of air. However, the hydroponic cultivation apparatus 100 may not have the supporting portion 70 in a case where the flow path 20 of air is not required or in a case where a vending air opening is provided in the cultivation tank 80. In these cases, each of the plate like members 1, 2, and 3 may be fixed directly to the upper end of the cultivation tank 80.

The hydroponic cultivation apparatus 100 is provided with a fixing screw 61 for fixing the supporting portion 70, in particular, the frame portion 71 and each of the plate members 1, 2, and 3. The supporting portion 70 is fixed to the cultivation tank 80, and the plate like members 1, 2, and 3 are indirectly fixed to the cultivation tank 80 via the supporting portion 70. The plate like members 1, 2, and 3 may be fixed to the supporting portion 70 by means of nail, adhesive, cellophane tape, hook-and-loop fastener (Velcro tape (registered trademark)) or the like, instead of the screws 6. According to this, the positions of the plate like members 1, 2, and 3 with respect to the cultivation tank 80 can be fixed. Therefore, it is possible to suppress the stems of the plants 10 from damaging due to the movement of the partitioning portion 50.

As shown in FIG. 7, the partitioning portion 50 partitions the aboveground space 11A where the aboveground part 11 of the plant 10 grows and the underground space 12A where the underground part 12 of the plant 10 grows. The partitioning portion 50 includes the fixed member 123 and the door member 4 described above.

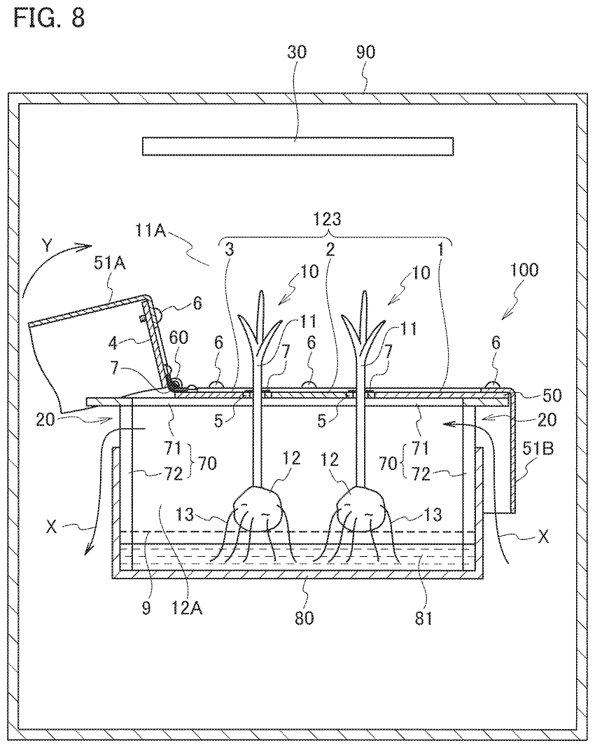

As shown in FIG. 8, the door member 4 is rotated around the rotation axis of the hinge 60 in the direction indicated by the arrow Y during the cultivation of the plant 10. Thereby, the door member 4 can be opened. At this time, since the door light shielding member 51A is attached to the door member 4 with the screw 6 for temporally fixing, it moves together with the door member 4. Therefore, the breeder of the plant 10 can view the state of the underground part 12 of the plant 10 during its growth. As for FIG. 8, since the door light shielding member 51A has a certain degree of hardness, it is drawn so that its shape does not change with the movement of the door member 4. However, when the door light shielding member 51A is formed of a flexible sheet, cloth, vinyl, or the like, its shape may be changed by the opening and closing operation of the door member 4.

As can be seen from FIG. 8, the position of the fixed member 123 with respect to the cultivation tank 80 is fixed, and the fixed member 123 maintains a closed state that suppresses light from entering the underground space 12A. On the other hand, the door member 4 is attached to the fixed member 123 in a state where the same is movable with respect to the fixed member 123, and changes to a closed state where light enters the underground space 12A and to an open state where it is possible to view the underground space 12A. In other words, the door member 4 changes to a closed state where the underground part 12 of the plant 10 is irradiated with light or to an open state where the underground part 12 of the plant 10 can be visually recognized. Therefore, the breeder of the plant 10 can view the underground part 12 of the plant 10 in the space inside the cultivation tank 80 from above the cultivation tank 80 by opening the door member 4. In other word, the underground part 12 in the cultivation tank 80 can be viewed by a simple operation of opening the door member 4. In addition, if the door member 4 is opened, it is possible to readily photograph the underground part 12.

As shown in FIG. 8, the light shielding member 7 is flexible enough to be folded along the rotation axis of the hinge 60 when the door member 4 is opened. Therefore, the light shielding member 7 does not hinder the opening and closing operation of the door member 4. Further, the light shielding member 7 is not broken by the opening and closing operation of the door member 4.

As shown in FIG. 8, in the present embodiment, the door member 4 is a hinged door attached to the fixed member 123 via the hinge 60 and rotatable with respect to the fixed member 123. However, the door member 4 may be a sliding door that is slidably inserted into grooves of the fixed member 123.

As shown in FIG. 8, the door member 4 constitutes an end portion of the partitioning portion 50. Therefore, even without providing a handle on the door member 4, the breeder of the plant 10 can readily open the door member 4.

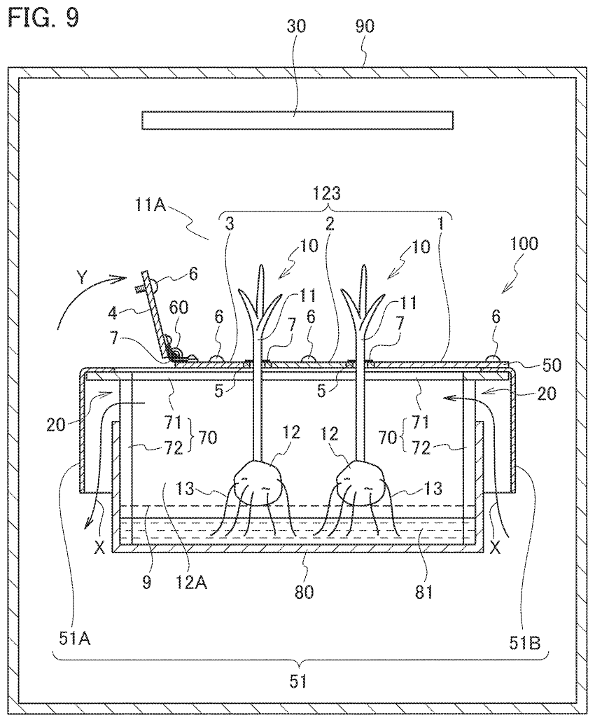

Next, with reference to FIG. 9, a light shielding member of a modified example of the hydroponic cultivation apparatus 100 of the embodiment will be described. As shown in FIG. 9, the light shielding member 51 of the modified example of the hydroponic culture apparatus 100 of the embodiment is fixed to the frame portion 71. In other words, the light shielding member 51 is sandwiched by the partitioning portion 50 and the frame portion 71. In this case, the light shielding member 51 does not move together with the door member 4, and always covers the flow path 20 of air. In other words, only the door member 4 is opened or closed. Therefore, it is possible to readily open and close the door member 4. In addition, the fixed light shielding member 51B and the door light shielding member 51A that are shown in FIG. 4 are not separated and may be integrally molded. Furthermore, although the light shielding member 51 has the same shape as the whole shape shown in FIG. 4, it may be formed by assembling a series of thin plates or stitching vinyl sheets or the like. In other words, in the hydroponic cultivation apparatus 100 of the modified example as well, the light shielding member 51 surrounds the side surfaces of the cultivation tank 80 in a plan view and the flow path 20 of air extends downward along the side surfaces of the cultivation tank 80, as long as it hangs from the outer periphery of the partitioning portion 50. This also makes it possible to ventilate the underground space 12A while suppressing light from entering the underground space 12A through the flow path 20 of air. Further, according to this modified example, since the light shielding member 51 can be formed as one part, it is possible to form the light shielding member 51 more readily.

Hereinafter, the characteristic configurations of the hydroponic cultivation apparatus 100 according to the embodiment and the effects obtained thereby will be described.

(1) The hydroponic cultivation apparatus 100 is provided with the cultivation tank 80 that has a light shielding property and the partitioning portion 50 that has a light shielding property. The cultivation tank 80 is configured to accommodate the underground part 12 of the plant 10. The partitioning portion 50, which has a light shielding property, is provided so as to cover the opening at the upper end of the cultivation tank 80, and partitions the underground space 12A where the underground part 12 of the plant 10 grows and the aboveground space 11A where the aboveground part 11 of the plant 10 grows. The partitioning portion 50 includes the fixed member 123 and the door member 4. The position of the fixed member 123 with respect to the cultivation tank 80 is fixed, and the fixed member 123 has the through hole surrounding the stem of the plant 10, and maintains the closed state that suppresses light irradiation to the underground part 12 of the plant 10. The door member 4 is attached to the fixed member 123 in the state of being movable with respect to the fixed member 123, and changes to the closed state where it is suppressed that light is irradiated to the underground part 12 of the plant 10 and to the open state where it is possible to view the underground part 12 of the plant 10.

According to the above configuration, the breeder of the plant 10 can view the underground part 12 of the plant 10 in the space inside the cultivation tank 80 from above the cultivation tank 80 by opening the door member 4.

(2) The door member 4 may be a hinged door attached to the fixed member 123 via the hinge 60 and rotatable about the rotation axis of the hinge 60 with respect to the fixed member 123. In this case, it is preferable that the hydroponic cultivation apparatus 100 further comprises the light shielding member 7. The light shielding member 7 is provided so as to cover the gap between the door member 4 and the fixed member 123, and can be bended along the rotational axis of the hinge 60 when the door member 4 is opened.

According to the above configuration, it is possible that the light shielding member 7 suppresses light from entering the cultivation tank 80 from the gap between the door member 4 and the fixed member 123, without hindering the opening and closing operation of the door member 4.

(3) The door member 4 preferably constitutes the end portion of the partitioning portion 50. According to this, it is possible to readily open the door member 4 without providing a handle on the door member 4.

(4) The hydroponic cultivation apparatus 100 may further comprise the support portion 70 and the light shielding member 51. In this case, the supporting portion 70 is installed to the cultivation tank 80, and supports the partitioning portion 50 above the upper end portion of the cultivation tank 80 so that the flow path 20 of air is formed between the cultivation tank 80 and the partitioning portion 50. The light shielding member 51 surrounds the side surfaces of the cultivation tank 80 in a plan view and hangs down from the outer periphery of the partitioning portion 50 so that the flow path 20 of air extends downward along the side surfaces of the cultivation tank 80. The light shielding member 51 includes the fixed light shielding member 51B that is attached to the fixed member 123 and the door light shielding member 51A that is attached to the door member 4 and is separated from the fixed light shielding member 51B.

According to the above configuration, even if air is allowed to flow naturally between the inner space of the cultivation tank 80 and the outer space of the cultivation tank 80 via the flow path 20 of air, the light shielding member 51 can suppresses light from entering the cultivation tank 80 from a lateral position via the flow path 20 of air. In addition, when viewing the interior of the cultivation tank 80, it is possible to readily open the door member 4 together with the light shielding member 51.

(5) The fixed member 123 may include the adjacent plate like members 1, 2, and 3. In this case, the through hole is formed by a notch that is formed in the end surface of one of the adjacent plate like members 1, 2, and 3 or a pair of notches 1A, 2A, 2B and 3A that is formed on a pair of opposing surfaces of the adjacent plate like members 1, 2, and 3. According to this, it is possible to readily install the partitioning portion 50.

(6) It is preferable that the elastic member 5, which closes the gap between the stem of the plant 10 and the notch, and elastically deforms depending on the shape of the stem is attached to the inner surface of the notch 1A, 2A, 2B, or 3A. According to this, it is suppressed that light is irradiated to the underground part 12 of the plant 10 through the gap between the stem of the plant 10 and the notch.

(7) It is preferable to further comprise the light shielding member 7 that covers a gap between the adjacent plate like members 1, 2, and 3. According to this, it is suppressed that light is irradiated to the underground part 12 of the plant 10 through the gap between the stem of the plant 10 and the notch.

This application claims the priority based on Japanese Patent Application No. 2016-021862, which was filed on Feb. 8, 2016, and its entire content is herein incorporated by reference.

### REFERENCE SIGNS LIST

1, 2, 3 plate like member
1A, 2A, 2B, 3A notch (through hole)
4 door member
5 elastic member
7 light shielding member
10 plant
11 aboveground part
11A aboveground space
12 underground part
12A underground space
20 flow path of air
50 partitioning part
51 light shielding member
51B fixed light shielding member
51A door light shielding member
60 hinge
70 supporting portion
80 cultivation tank
100 hydroponic cultivation apparatus
123 fixed member

1. A hydroponic cultivation apparatus comprising:
a cultivation tank that has a light shielding property and is configured to accommodate underground part of a plant; and
a partitioning portion that has a light shielding property and that is provided so as to cover an opening at an upper end of the cultivation tank and partitions an underground space where the underground part of the plant grows and an aboveground space where aboveground part of the plant grows,
the partitioning portion includes:
a fixed member, a position of which is fixed with respect to the cultivation tank, and including a through hole surrounding a stem of the plant and maintains a closed state where it is suppressed that light is irradiated to the underground part of the plant; and
a door member that is attached to the fixed member in a state of being movable with respect to the fixed member and changes to a closed state where it is suppressed that light is irradiated to the underground part of the plant and to an open state where it is possible to view the underground part of the plant.

2. The hydroponic cultivation apparatus according to claim 1, wherein the door member is a hatch door that is attached to the fixed member via a hinge and is rotatable about a rotational axis of the hinge with respect to the fixed member and,
the hydroponic cultivation apparatus further comprises a light shield member that is provided so as to cover a gap between the door member and the fixed member and can be bended along the rotational axis of the hinge when the door member is opened.

3. The hydroponic cultivation apparatus according to claim 1, wherein the door member constitutes an end portion of the partitioning portion.

4. The hydroponic cultivation apparatus according to claim 1, further comprising:
a supporting member that is installed to the cultivation tank and supports the partitioning portion above the upper end portion of the cultivation tank so that a flow path of air is formed between the cultivation tank and the partitioning portion; and
a light shielding member that surrounds a side surface or side surfaces of the cultivation tank in a plan view and hangs from an outer periphery of the partitioning portion so that the flow path of air extends downward along the side surface or the side surfaces of the cultivation tank, wherein
the light shielding member includes:
a fixed light shielding member that is attached to the fixed member; and
a door light shielding member that is attached to the door member and is separated from the fixed light shielding member.

5. The hydroponic cultivation apparatus according to claim 1, wherein
the fixed member includes adjacent plate like members, wherein
the through hole is formed by a notch that is formed at an end surface of one of the adjacent plate like members or a pair of notches that is provided on a pair of opposing surfaces of the adjacent plate like members.

6. The hydroponic cultivation according to claim 5, wherein
an elastic member that closes a gap between the stem of the plant and the notch, and elastically deforms depending on a shape of the stem

7. The hydroponic cultivation according to claim 5, further comprising another light shielding member covering a gap between the adjacent plate like members.
